(19) United States
(12) Patent Application Publication
(10) Pub. No.: US 2026/0209952 A1
(43) Pub. Date: Jul. 23, 2026

(54) UNIQUE COLORED RESISTANT TO CORROSION METAL

(71) Applicant: NOVET GROUP LTD, RISHPON (IL)

(72) Inventor: Sharon Abudi, RISHPON (IL)

(21) Appl. No.: 19/456,613

(22) Filed: Jan. 22, 2026

(30) Foreign Application Priority Data
Jan. 23, 2025 (IL) 318589

(51) Int. Cl. C23F 11/00

(52) U.S. Cl. CPC C23F 11/00

(57) ABSTRACT

A unique colored resistant to corrosion metal, created by applying oxidants on the surface of the metal. The method for coloring metal and protecting the metal from corrosion is described, and the result is a metal surface having a unique rust-like hue and is resistant to corrosion. The metal surface can be used for metal window boxes, or any other outdoor product.

### FIELD OF THE INVENTION

The present invention relates to a unique colored resistant to corrosion metal and a method for coloring and protecting metal from corrosion and in particular to resistant to corrosion window boxes.

### BACKGROUND OF THE INVENTION

Nowadays, people who buy metal window boxes suffer from rusting of the window boxes and therefore, usually do not use metal window boxes. Furthermore, a window box is expected to look appealing, and therefore to have a designed attractive color. There have been a few attempts to create a resistant to corrosion metals or to create a special color to fit the window boxes.

U.S. Pat. No. 7,507,480 discloses metal surfaces having thereon an ultrathin (e.g., less than ten nanometer thickness) corrosion-resistant film, thereby rendering the metal surfaces corrosion-resistant. The corrosion-resistant film includes an at least partially crosslinked amido-functionalized silanol component in combination with rare-earth metal oxide nanoparticles. Nevertheless, the unique color does not appeal according to this invention.

It is possible to paint galvanized metals in a desired color, such as U.S. Pat. No. 8,790,438, but this action does not achieve the effect of the rust-like hue and the passivation process.

It is an object of the present invention to provide a unique colored resistant to corrosion metal that significantly reduces or overcomes the aforementioned disadvantages. Furthermore, it is an object of the present invention to provide a unique colored resistant to corrosion metal which enables to apply the invention on, among other products, window boxes, therefore enables the use of metal window boxes which can last for a long time with a beautiful unique color.

It is a further object of the present invention to provide a method for coloring and protecting metal from corrosion. The current method achieves permanent preservation, anti-rust, and a unique color that is preserved for a long time.

### SUMMARY OF THE INVENTION

In accordance with the present invention, there is provided a metal having a metal surface; wherein

after applying oxidants, the metal surface has a unique rust-like hue and is resistant to corrosion.

In accordance with embodiments of the present invention, the metal surface is black metal ST 37.

In accordance with embodiments of the present invention, the metal is a window box.

In accordance with embodiments of the present invention, the oxidants are Antox 71 E Plus.

In accordance with embodiments of the present invention, the active substances in the Antox 71 E Plus are Nitric Acid and Hydrofluoric Acid.

In accordance with embodiments of the present invention, the metal surface has a component to create the paste.

In accordance with embodiments of the present invention, the paste has Magnesium Fluoride.

In accordance with embodiments of the present invention, the paste has Poly Glutamic Acid.

In accordance with embodiments of the present invention, the concentration of the Nitric Acid is between 2% and 15%.

In accordance with embodiments of the present invention, the concentration of the Hydrofluoric Acid is between 2% and 20%

In accordance with embodiments of the present invention, the concentration of the Magnesium Fluoride is between 4% and 30%.

In accordance with embodiments of the present invention, the concentration of the paste is above 80%.

There is also provided in accordance with embodiments of the present invention a method for coloring metal and protecting the metal from corrosion, the method having the steps of:
(i) providing metal;
(ii) applying oxidants on the surface of the metal;
(iii) drying the metal surface; wherein the color becomes darker; and
(iv) washing the metal surface with water when the required color is obtained.

In accordance with some embodiments of the present invention, applying oxidants in step (ii) is done by spreading the oxidants on the metal surface.

In accordance with some embodiments of the present invention, when drying the metal surface between minutes and 24 hours, the color of the metal surface becomes brown.

In accordance with some embodiments of the present invention, when drying the metal surface between 24 hours and 48 hours, the color of the metal surface becomes dark red.

In accordance with some embodiments of the present invention, when drying the metal surface between 48 hours and 72 hours, the color of the metal surface becomes light red.

In accordance with some embodiments of the present invention, step (iv) is done when the required color is obtained.

The present invention has the preferred advantages as to an improved metal or metal surface, such as of a window box, and a method for creating such a metal surface, which improves the lifetime of the product. Furthermore, the final product is more aesthetic.

Further or additional preferred advantages of the present invention are obvious from the general discussion above as well as the detailed discussion of the invention as provided below.

### BRIEF DESCRIPTION OF THE DRAWINGS

For a better understanding of the present invention and to show how the same may be carried out in practice, reference will now be made to the accompanying drawings, in which:

FIG. 1 is a side view of a window box according to the present invention, before applying anything on it;

FIG. 2 is a side view of a window box shown in FIG. 1 after applying oxidants on it;

FIG. 3 is a side view of a window box shown in FIG. 1 in its final stage after applying oxidants; and

FIG. 4 is a side view of a window box shown in FIG. 3 in its final stage after applying oxidants for a longer time.

### DETAILED DESCRIPTION OF THE PRESENT INVENTION

The patent or application file contains at least one drawing executed in color. Copies of this patent or patent application publication with color drawing(s) will be provided by the Office upon request and payment of the necessary fee.

Attention is drawn to FIG. 1, showing a metal piece 20 in accordance with the present invention. The metal 20 in this description may represent a window box 22, but can also be any other item made of metal. The metal can be steel, aluminum, iron or any other metal group. The metal 20 may be black metal ST 37. The metal piece 20 has a metal surface 24. The product may be made of other material but coated with the metal surface 24. FIG. 1 shows the window box 22 at the original state before being treated. The color of the metal surface 24 at this stage is black.

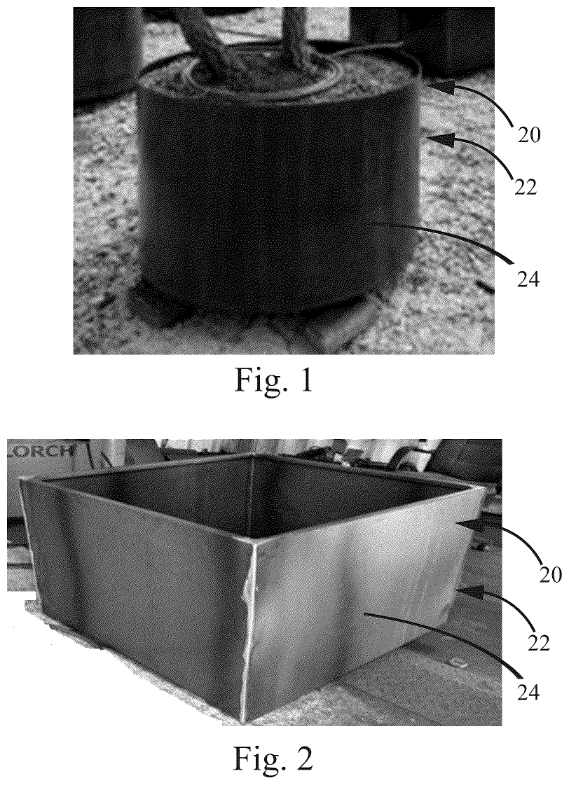

Attention is drawn to FIG. 2, showing the metal piece 20 after applying oxidants on it. The oxidants may be Antox 71 E Plus or another material with a composition which includes Nitric Acid and Hydrofluoric Acid. The concentration of the Nitric Acid may be between 5% and 7%. A smaller concentration of the Nitric Acid may be used, such as between 2% and 3%, which will extend the duration of the process to occur. A bigger concentration of the Nitric Acid may be used, such as between 12% and 15%, which will shorten the duration of the process to occur. The concentration of the Hydrofluoric Acid is between 5% and 9%. Here as well, a smaller concentration of the Hydrofluoric Acid may be used, such as between 2% and 3%, which will extend the duration of the process to occur, or a bigger concentration of the Hydrofluoric Acid may be used, such as between 15% and 20%, which will shorten the duration of the process to occur. These two substances are the active substances in the process. The Nitric Acid creates the layer of passivation which prevents the corrosion, and the Hydrofluoric Acid consumes the black coating and creates a unique red rust-like color. Another included substance may be Magnesium Fluoride. The concentration of the Magnesium Fluoride may be between 10% and 12.5%, and here as well, a smaller concentration of the Magnesium Fluoride may be used, such as between 4% and 5%, which will extend the duration of the process to occur, or a bigger concentration of the Magnesium Fluoride may be used, such as between 25% and 30%, which will shorten the duration of the process to occur. Other substances may include any substance creating the paste needed to apply on the metal, a component which does not affect the process, but only helps to create the paste or the gel facilitating the industrial use of the Antox 71 E Plus. Such a substance may include Poly Glutamic Acid, for example. The concentration of this neutral substance is the majority of the total concentration of all the substances, above 80%, such as 84% or between 84% and 90%, and it depends on the concentration of the rest of the substances, i.e. the neutral substance completes the percentages of the components of the paste to 100%, according to the percentages of the components of the other substances.

After applying these oxidants, the color changes from black to more rust-like hue. It may be its final hue, or it may be that the color will keep changing to a darker or lighter option. All the mentioned options create a resistant to corrosion surface.

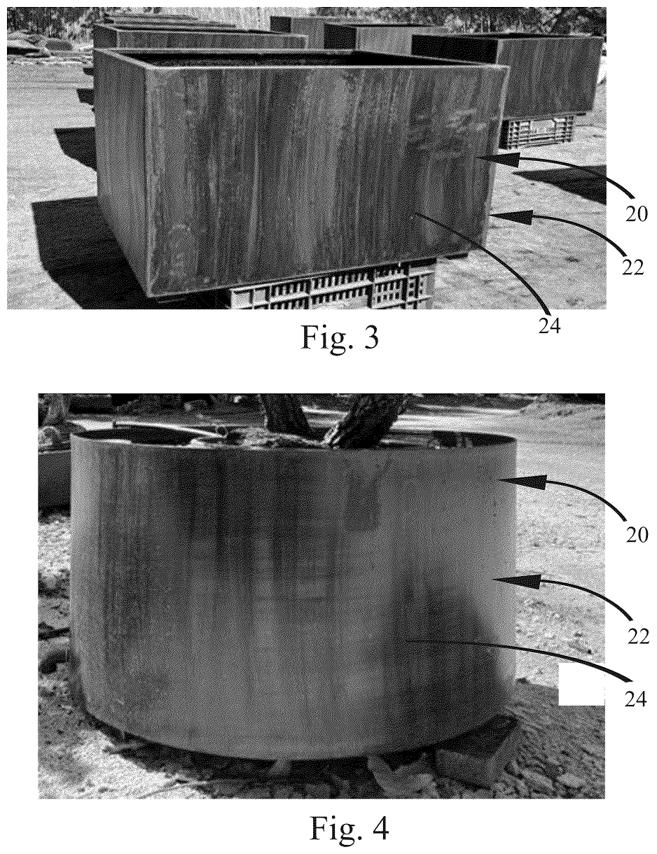

Attention is drawn to FIG. 3, showing the metal piece 20 at its final stage, creating the unique desired color. FIG. 4 shows the metal piece 20 after two years, showing the desired unique color remained with a rust-like hue and resistant to corrosion.

The invention also includes a method for coloring metal 20 and protecting the metal 20 from corrosion, the method includes the following steps:
(i) providing metal 20;
(ii) spreading oxidants on the surface 24 of the metal 20.
(iii) drying the metal surface 24. After twenty minutes up to 3 days, the hue becomes darker, and the substance changes from black to brown and to red, according to the following time frame: in the range of between one hour to twenty four hours, the hue changes from black to brown. During the next twenty-four hours, the hue changed to red.
   When the desired hue is achieved, the process may be stopped, including the following step:
(iv) washing the metal surface 24 with water, the result is that the required color is obtained and the passivation process is stopped.
   The result is a that the rusting process is stopped, therefore the metal surface 24 is protected from any weather, and a unique desired color is obtained permanently.
It will be appreciated that the present invention not only provides a unique colored resistant to corrosion metal 20 and a method for coloring metal 20 and protecting the metal 20 from corrosion, but the results are obtained together in one action, therefore saving time and money, and at the same time remain permanently.

Although the present invention has been described to a certain degree of particularity, it should be understood that various alterations and modifications could be made without departing from the scope of the invention as hereinafter claimed.

1. A metal (20) comprising metal surface; wherein after applying oxidants, the metal surface (24) comprises a unique rust-like hue and is resistant to corrosion.

2. The metal surface (24) according to claim 1 is black metal ST 37.

3. The metal surface (24) according to claim 1, wherein the metal is a window box (22).

4. The metal surface (24) according to claim 1, wherein the oxidants are Antox 71 E Plus.

5. The metal surface (24) according to claim 4, wherein the active substances in the Antox 71 E Plus are Nitric Acid and Hydrofluoric Acid.

6. The metal surface (24) according to claim 1, wherein the metal surface (24) comprises a component to create the paste.

7. The metal surface (24) according to claim 6, wherein the paste comprises Magnesium Fluoride.

8. The metal surface (24) according to claim 6, wherein the paste comprises Poly Glutamic Acid.

9. The metal surface (24) according to claim 5, wherein the concentration of the Nitric Acid is between 2% and 15%.

10. The metal surface (24) according to claim 5, wherein the concentration of the Hydrofluoric Acid is between 2% and 20%.

11. The metal surface (24) according to claim 7, wherein the concentration of the Magnesium Fluoride is between 4% and 30%.

12. The metal surface (24) according to claim 6, wherein the concentration of the paste is above 80%.

13. A method for coloring metal (20) and protecting the metal (20) from corrosion, the method comprising the steps of:
(i) providing metal (20);
(ii) applying oxidants on the surface (24) of the metal (20);
(iii) drying the metal surface (24); wherein the color becomes darker; and
(iv) washing the metal surface (24) with water when the required color is obtained.

14. The method for coloring metal (20) and protecting the metal (20) from corrosion according to claim 13, wherein applying oxidants in step (ii) is done by spreading the oxidants on the metal surface (24).

15. The method for coloring metal (20) and protecting the metal (20) from corrosion according to claim 13, wherein when drying the metal surface (24) between minutes and 24 hours, the color of the metal surface (24) becomes brown.

16. The method for coloring metal (20) and protecting the metal (20) from corrosion according to claim 15, wherein when drying the metal surface (24) between 24 hours and 48 hours, the color of the metal surface (24) becomes dark red.

17. The method for coloring metal (20) and protecting the metal (20) from corrosion according to claim 16, wherein when drying the metal surface (24) between 48 hours and 72 hours, the color of the metal surface (24) becomes light red.

18. The method for coloring metal (20) and protecting the metal (20) from corrosion according to claim 16, wherein step (iv) is done when the required color is obtained.

19. The method for coloring metal (20) and protecting the metal (20) from corrosion according to claim 13, wherein the metal is black metal ST 37.

20. The method for coloring metal (20) and protecting the metal (20) from corrosion according to claim 13, wherein the metal is a window box (22).

21. The method for coloring metal (20) and protecting the metal (20) from corrosion according to claim 13, wherein the applied material on the metal is oxidants are Antox 71 E Plus.
